(19) United States
(12) Patent Application Publication
(10) Pub. No.: US 2025/0211427 A1
(43) Pub. Date: Jun. 26, 2025

(54) APPARATUS AND METHOD FOR PROVIDING MULTI-PARTY COMPUTATION SERVICE

(71) Applicant: ELECTRONICS AND TELECOMMUNICATIONS RESEARCH INSTITUTE, Daejeon (KR)

(72) Inventors: Seok-Hyun KIM, Daejeon (KR); Sang-Rae Cho, Daejeon (KR); Kwan-Tae Cho, Daejeon (KR); Soo-Hyung Kim, Sejong-si (KR); Young-Sam Kim, Daejeon (KR); Jong-Hyouk Noh, Daejeon (KR); Young-Seob Cho, Daejeon (KR); Jin-Man Cho, Daejeon (KR); Seung-Hun Jin, Daejeon (KR)

(73) Assignee: ELECTRONICS AND TELECOMMUNICATIONS RESEARCH INSTITUTE, Daejeon (KR)

(21) Appl. No.: 18/826,552

(22) Filed: Sep. 6, 2024

(30) Foreign Application Priority Data
Dec. 26, 2023 (KR) 10-2023-0191239

(51) Int. Cl. H04L 9/08; H04L 9/32

(52) U.S. Cl. CPC H04L 9/085; H04L 9/3263; H04L 2209/46

(57) ABSTRACT

Disclosed herein is an apparatus and method for providing a multi-party computation service. The apparatus prepares a preconfiguration in response to a request from a user device to execute a multi-party computation service, requests multi-party computation player servers participating in the multi-party computation service to perform a preconfiguration based on multi-party computation runtime environment data, executes multi-party computation with the multi-party computation player servers depending on the preconfiguration, and replies to the user device with a result of execution of the multi-party computation service based on a result of executing the multi-party computation.

### CROSS REFERENCE TO RELATED APPLICATION

This application claims the benefit of Korean Patent Application No. 10-2023-0191239, filed Dec. 26, 2023, which is hereby incorporated by reference in its entirety into this application.

### BACKGROUND OF THE INVENTION

### 1. Technical Field

The present disclosure relates generally to Multi-Party Computation (MPC) technology, and more particularly to technology for providing an MPC service by executing and operating various types of MPC programs.

### 2. Description of the Related Art

Multi-Party Computation (MPC) is cryptographic protocol technology that allows two or more participants or computing entities to jointly process and compute data while preserving privacy. Accordingly. all participants in multi-party computation are able to perform computation with other participants without revealing their own data.

The basic operation of general-purpose multi-party computation may be broadly divided into a preparation step and an execution step.

All participants prepare their input data and select the same MPC protocol and the same MPC program for multi-party computation. The MPC protocol defines a method for secure interaction with other participants and a computation process, and all participants should select and compile the same MPC protocol. If there is a participant who selects a different MPC protocol, multi-party computation cannot be run. There are various MPC protocols, and a protocol suitable for a specific situation and requirements may be selected. The MPC program is a program implemented to compute data input by all participants in the state in which the data is encrypted and to return the computation result to all of the participants or a specific participant. The MPC program cannot execute multi-party computation unless input data defined in the program is input. Therefore, it is important that all participants prepare input data.

All participants in multi-party computation execute the MPC program on their systems. If not all of the participants execute the MPC program, the input data defined in the MPC program is not input, so multi-party computation cannot be run. When all of the participants execute the MPC program, their systems encrypt the input data thereof based on the MPC protocol and program, share the same with other participants, and perform multi-party computation on the encrypted input data. Accordingly, all of the participants perform the computation without being able to see the input data of other participants, and they are able to check only the computation result.

In order to execute multi-party computation, all participants need to perform a number of preconfiguration tasks, such as setting input data required for multi-party computation, setting the same MPC protocol and the same program, and the like, before executing the MPC program. Also, even though the same MPC programs are used, when the number of participants or information about the MPC program changes, the MPC program and the execution environment settings for the MPC program also change, which results in various management problems, such as redistribution of the changed MPC program, or the like. Accordingly, a lot of inconvenience may be caused in management and execution of various MPC programs on a single server and there is a high probability of human errors.

Meanwhile, Korean Patent Application Publication No. 10-2016-0105717, titled “Method and system for multi-party computation capable of detecting malicious user” discloses a method for performing multi-party computation on a first secret value, which is the secret value of a first user device, and a second secret value, which is the secret value of a second user device, using a multi-party computation system including multiple user devices and a verification server for detecting malicious users.

### SUMMARY OF THE INVENTION

An object of the present disclosure is to provide the structure of a general-purpose MPC server capable of easily providing MPC preconfiguration and execution tasks for executing a multi-party computation program and the operation method thereof.

Another object of the present disclosure is to conveniently manage and stably operate various MPC programs.

A further object of the present disclosure is to facilitate system expansion by easily adding and managing players participating in multi-party computation.

In order to accomplish the above objects, an apparatus for providing a multi-party computation service according to an embodiment of the present disclosure includes one or more processors and memory for storing at least one program executed by the one or more processors, and the at least one program prepares a preconfiguration in response to a request from a user device to execute a multi-party computation service, requests multi-party computation player servers participating in the multi-party computation service to perform a preconfiguration based on multi-party computation runtime environment data, executes multi-party computation with the multi-party computation player servers depending on the preconfiguration, and replies to the user device with a result of execution of the multi-party computation service based on a result of executing the multi-party computation.

Here, the at least one program may receive a multi-party computation program identifier and a user identifier and check whether a multi-party computation program and multi-party computation runtime environment data associated with the multi-party computation program identifier are stored.

Here, the at least one program may identify the IP information of the multi-party computation player servers in the multi-party computation runtime environment data associated with the multi-party computation program identifier and generate a link for requesting the multi-party computation player servers to perform the preconfiguration based on the IP information.

Here, the at least one program may check the player identifier numbers of the multi-party computation player servers, which are received as a result of a response to the request to perform the preconfiguration, and may update the multi-party computation execution preparation states of the multi-party computation player servers corresponding to the player identifier numbers to an enabled state.

Here, each of the multi-party computation player servers may check a player identifier number matching the IP address thereof by retrieving network information in the multi-party computation runtime environment data.

Here, the at least one program may retrieve the network information and establish SSL communication with the multi-party computation player servers based on a certificate file and the CommonName (CN) value of a certificate.

Here, the user device may output a Graphical User Interface (GUI) for retrieving the multi-party computation runtime environment data to a user.

Here, the user device may receive network information, multi-party computation runtime environment data, and a certificate file from the user via the GUI.

Here, the user device may output a GUI for retrieving an execution log, including the multi-party computation program that executed the multi-party computation, a computation start time, and a computation end time, to a user.

Here, the user device may request a multi-party computation player server to prepare a client preconfiguration by receiving data for processing the multi-party computation, and when preparation of the client preconfiguration is completed, the user device may transfer a request to execute the multi-party computation service to the apparatus.

Also, in order to accomplish the above objects, a method for providing a multi-party computation service, performed by an apparatus for providing a multi-party computation service, according to an embodiment of the present disclosure includes preparing a preconfiguration in response to a request from a user device to execute a multi-party computation service, requesting multi-party computation player servers participating in the multi-party computation service to perform a preconfiguration based on multi-party computation runtime environment data, executing multi-party computation with the multi-party computation player servers depending on the preconfiguration, and replying to the user device with a result of execution of the multi-party computation service based on a result of executing the multi-party computation.

Here, preparing the preconfiguration may comprise receiving a multi-party computation program identifier and a user identifier and checking whether a multi-party computation program and multi-party computation runtime environment data associated with the multi-party computation program identifier are stored.

Here, requesting to perform the preconfiguration may comprise identifying the IP information of the multi-party computation player servers in the multi-party computation runtime environment data associated with the multi-party computation program identifier and generating a link for requesting the multi-party computation player servers to perform the preconfiguration based on the IP information.

Here, executing the multi-party computation may comprise checking the player identifier numbers of the multi-party computation player servers, which are received as a result of a response to the request to perform the preconfiguration, and updating the multi-party computation execution preparation states of the multi-party computation player servers corresponding to the player identifier numbers to an enabled state.

Here, executing the multi-party computation may comprise checking, by each of the multi-party computation player servers, a player identifier number matching the IP address thereof by retrieving network information in the multi-party computation runtime environment data.

Here, executing the multi-party computation may comprise retrieving the network information and establishing SSL communication with the multi-party computation player servers based on a certificate file and the CommonName (CN) value of a certificate.

Here, the user device may output a GUI for retrieving the multi-party computation runtime environment data to a user.

Here, the user device may receive network information, multi-party computation runtime environment data, and a certificate file from the user via the GUI.

Here, the user device may output a GUI for retrieving an execution log, including the multi-party computation program that executed the multi-party computation, a computation start time, and a computation end time, to a user.

Here, preparing the preconfiguration may comprise requesting, by the user device, a multi-party computation player server to prepare a client preconfiguration by receiving data for processing the multi-party computation and transferring, by the user device, a request to execute the multi-party computation service to the apparatus for providing a multi-party computation service when preparing the client preconfiguration is completed.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating a multi-party computation apparatus according to an embodiment of the present disclosure;

FIG. 2 is a view illustrating a general-purpose MPC server operating environment according to an embodiment of the present disclosure;

FIG. 3 is a block diagram illustrating in detail the functions of the MPC execution unit illustrated in FIG. 1 and FIG. 2;

FIG. 4 is a flowchart illustrating an MPC program execution procedure of an apparatus for providing a multi-party computation service according to an embodiment of the present disclosure;

FIG. 5 is a view illustrating an operating procedure of a multi-party computation system according to an embodiment of the present disclosure;

FIGS. 6 and 7 are sequence diagrams illustrating a method for providing a multi-party computation service according to an embodiment of the present disclosure;

FIG. 8 is a view illustrating a GUI for retrieving and managing MPC runtime environment configuration data of an MPC execution administrator according to an embodiment of the present disclosure;

FIG. 9 is a view illustrating a GUI for retrieving and managing MPC runtime environment configuration data of a general MPC player according to an embodiment of the present disclosure;

FIG. 10 is a view illustrating a GUI for additionally storing MPC runtime environment configuration data according to an embodiment of the present disclosure;

FIG. 11 is a view illustrating a GUI for retrieving an MPC program execution log according to an embodiment of the present disclosure;

FIG. 12 is a view illustrating a GUI for setting an MPC program runtime environment according to an embodiment of the present disclosure; and

FIG. 13 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

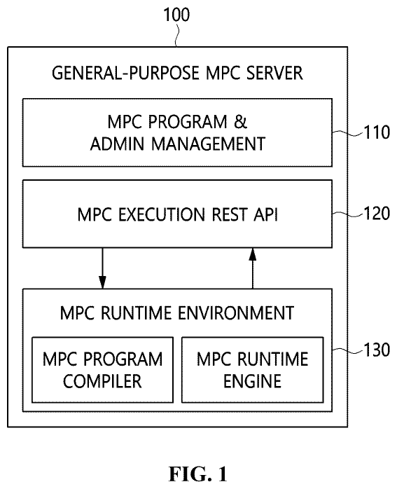

FIG. 1 is a block diagram illustrating a multi-party computation apparatus according to an embodiment of the present disclosure.

Referring to FIG. 1, it can be seen that a general-purpose MPC server is illustrated as an example of a multi-party computation apparatus 100.

The multi-party computation apparatus 100 includes an MPC program and administrator management unit (MPC Program & Admin Management) 110, an MPC execution unit (MPC execution REST API) 120, and an MPC runtime environment management unit (MPC Runtime Environment) 130.

The MPC program and administrator management unit 110 may store and manage a Multi-Party Computation (MPC) program and MPC runtime environment configuration data for the MPC program based on a Graphical User Interface (GUI).

The MPC execution unit 120 may include a set of web APIs capable of handling an MPC preconfiguration task, such as setting input data and the same MPC protocol and MPC program for all players, and an MPC execution task in order to execute the multi-party computation program.

The MPC runtime environment management unit 130 may include a multi-party computation platform or runtime environment designed to be able to preserve privacy for input data by enabling computation on the input data of players without revealing the input data of all of the players.

The MPC runtime environment management unit 130 may include an MPC compiler and an MPC runtime engine.

The MPC compiler may provide a function to convert an MPC program into a byte code format executable in the MPC runtime engine.

The MPC runtime engine is a set of threads that execute a sequence of instructions encoded in the byte code format and may provide functions to generate point-to-point communication channels with relevant threads in the runtime environments of all players and to exchange and process encrypted data.

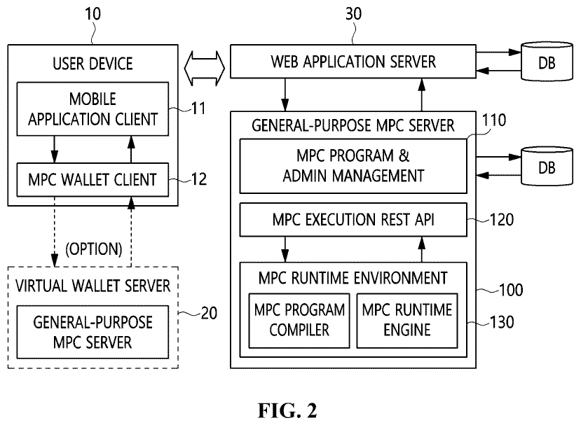

FIG. 2 is a view illustrating a general-purpose MPC server operating environment according to an embodiment of the present disclosure.

Referring to FIG. 2, a user device 10 may include a mobile application client 11 and an MPC wallet client 12.

The mobile application client 11 is a mobile application for using the service of an application server.

The MPC wallet client 12 is a mobile application capable of performing multi-party computation between general-purpose MPC servers.

A virtual wallet server 20 is a server capable of performing multi-party computation between general-purpose MPC servers, and may handle a request for multi-party computation from the mobile application when the MPC wallet client cannot perform multi-party computation by itself due to a problem such as the performance of a user terminal, limited hardware resources, or the like.

A web application server 30 may ensure data privacy for personal information or confidential information of a user by utilizing the multi-party computation technology.

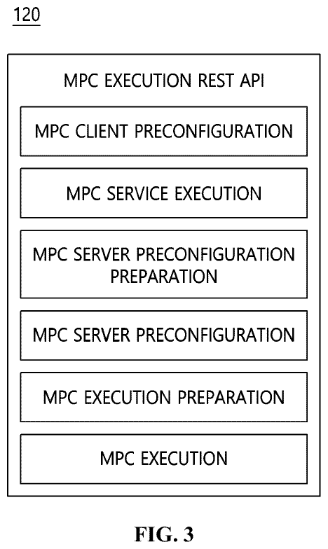

FIG. 3 is a block diagram illustrating in detail the functions of the MPC execution unit illustrated in FIG. 1 and FIG. 2.

Referring to FIG. 3, the MPC execution unit (MPC Execution REST API) 120 may perform an MPC client preconfiguration function, a multi-party computation service execution function, an MPC server preconfiguration preparation function, an MPC preconfiguration function, an MPC execution preparation function, and an MPC execution function.

It can be seen that the MPC execution unit (MPC Execution REST API) 120 indicates common MPC execution REST API functions required for running various types of multi-party computation (MPC) programs.

The MPC client preconfiguration function may process a function to set MPC input data for a client-type player, among MPC player types, and a function to set MPC runtime environment data associated with the MPC program to be executed.

The MPC client preconfiguration function may be executed when a user who is the client makes a request.

The MPC client preconfiguration function may receive an MPC program identifier, a user ID, a personal information identifier, and user input information.

The MPC client preconfiguration function may check whether the MPC program and MPC runtime environment data associated with the received MPC program identifier are stored.

Here, when the MPC program and the MPC runtime environment data are present, the MPC client preconfiguration function may install the MPC program and the MPC runtime environment data in the MPC runtime environment.

Also, the MPC client preconfiguration function may check the player identifier number thereof using MPC player network information in the retrieved MPC runtime environment data.

Here, the MPC client preconfiguration function may check the player identifier number matching the IP address thereof in the MPC player network information.

Also, when there is a received user ID or personal information identifier, the MPC client preconfiguration function may retrieve the personal information of a user from a user database (DB) and install the retrieved personal information in the MPC runtime environment as the input data of the player.

Here, if there is additionally received user input information, the MPC client preconfiguration function may also install the corresponding information as the input data of the MPC runtime environment.

Here, the user ID may be a user ID for the service or Connecting Information (CI) generated based on the social security number of the user.

Here, the CI may be used as user identification information for retrieving the personal information of the user registered in the systems of different players.

Also, the MPC client preconfiguration function may generate and return a result of processing the MPC client preconfiguration.

Here, the MPC client preconfiguration function may output a processing result code as success/failure.

Here, the MPC client preconfiguration function may output the MPC player identifier number.

The multi-party computation service execution function may process a series of functions for executing the MPC program that a user requests to execute, such as the preconfiguration and execution of the MPC program, checking of a result of the execution of the MPC program, and the like.

The multi-party computation service execution function may receive an MPC program identifier, an MPC player identifier number, a user ID, and a personal information identifier.

Here, the multi-party computation service execution function may check whether the MPC program and MPC runtime environment data associated with the received MPC program identifier are stored.

Here, when the MPC program and the MPC runtime environment data are present, the multi-party computation service execution function may install the MPC program and the MPC runtime environment data in the MPC runtime environment.

Also, the multi-party computation service execution function may check the player identifier number thereof using MPC player network information in the retrieved MPC runtime environment data.

Here, the multi-party computation service execution function may check the player identifier number matching the IP address thereof in the MPC player network information.

Here, the multi-party computation service execution function may update an MPC execution preparation state for the player identifier number thereof to an enabled state.

Also, when there is a received MPC player identifier number, the multi-party computation service execution function may update the MPC execution preparation state for the corresponding player identifier number to an enabled state in the MPC player network data.

Also, when there is a received user ID or personal information identifier, the multi-party computation service execution function may retrieve the personal information of the user from the user DB and install the retrieved personal information in the MPC runtime environment as the input data of the player.

Here, when there is additionally received user input information, the multi-party computation service execution function may also install the corresponding information as the input data of the MPC runtime environment.

Here, the user ID may be a user ID for the service or Connecting Information (CI) generated based on the social security number of the user.

Here, the CI is used as user identification information for retrieving the personal information of the user registered in the systems of different players.

Also, the multi-party computation service execution function requests preparation of an MPC server preconfiguration.

Also, the multi-party computation service execution function checks a result of the response to the request for the preparation of the MPC server preconfiguration, and when the preparation of MPC execution is completed for all players, the multi-party computation service execution function requests MPC execution preparation.

Also, the multi-party computation service execution function may check an MPC execution processing result based on a result of the response to the MPC execution preparation request and may generate and return a multi-party computation service execution result.

The multi-party computation service execution function may output a processing result code as success/failure.

The MPC server preconfiguration preparation function may identify the IP information of a server-type player in the MPC player network data associated with the MPC program to be executed and generate a link through which a request to perform an MPC server preconfiguration can be made to the identified server-type player. Only an MPC execution administrator may perform this function.

The MPC server preconfiguration preparation function may receive an MPC program identifier and a user ID.

The MPC server preconfiguration preparation function may check the received user ID.

Also, the MPC server preconfiguration preparation function may identify the IP information of server-type players in the MPC player network data for the MPC program associated with the received MPC program identifier and generate a link for requesting the MPC server preconfiguration for the server-type players as follows.

A link in the form of ‘https://IP address of the identified player/mpcXXX’ may be generated.

For example, a link such as [https://192.168.170.131/mpcSimple_sum, https://192.168.170.132/mpcSimple_sum] may be generated.

Also, the MPC server preconfiguration preparation function may set and request input parameter information required for the MPC server preconfiguration request.

The input parameter information may include the identifier of the MPC program to be executed, user ID information, and a personal information identifier.

Also, the MPC server preconfiguration preparation function may identify the MPC player identifier number received as a result of the response to the MPC server preconfiguration request and update the MPC execution preparation state for the corresponding MPC player identifier number to an enabled state.

Also, the MPC server preconfiguration preparation function may generate and return a result of processing the MPC server preconfiguration preparation.

The MPC server preconfiguration preparation function may output a processing result code as success/failure.

The MPC server preconfiguration function may process a function to set MPC input data for a server-type player, among the MPC player types, and a function to install the MPC program to be executed and the MPC runtime environment data associated with the MPC program in the MPC runtime environment.

Here, the MPC server preconfiguration function may be executed when the MPC execution administrator makes a request.

The MPC server preconfiguration function may receive an MPC program identifier, a user ID, and a personal information identifier.

The MPC server preconfiguration function may check whether the MPC program and MPC runtime environment data associated with the received MPC program identifier are stored.

Here, when the MPC program and the MPC runtime environment data are present, the MPC server preconfiguration function may install the MPC program and the MPC runtime environment data in the MPC runtime environment.

Also, the MPC server preconfiguration function may check the player identifier number thereof using the MPC player network information in the retrieved MPC runtime environment data.

Here, the MPC server preconfiguration function may check the player identifier number matching the IP address thereof in the MPC player network information.

Also, when there is a received user ID or personal information identifier, the MPC server preconfiguration function may retrieve the personal information of the user from the user DB and install the retrieved personal information in the MPC runtime environment as the input data of the player.

Here, the user ID may be a user ID for the service or Connecting Information (CI) generated based on the social security number of the user.

Here, the CI may be used as user identification information for retrieving the personal information of the user registered in the systems of different players.

Also, the MPC server preconfiguration function may generate and return a result of processing the MPC server preconfiguration.

Here, the MPC server preconfiguration function may output a processing result code as success/failure.

Here, the MPC server preconfiguration function may output the MPC player identifier number.

The MPC execution preparation function may identify the IP information of all players in the MPC player network data associated with the MPC program to be executed and generate a link through which a request to perform MPC execution can be made to all of the identified players. Only the MPC execution administrator may perform this function.

The MPC execution preparation function may receive an MPC program identifier.

The MPC execution preparation function may identify the IP information of all players in the MPC player network data for the MPC program associated with the received MPC program identifier, and may generate a link for requesting MPC execution for all of the players as follows

A link in the form of ‘https://IP address of the identified player/mpcRun’ may be generated.

For example, a link such as [https://192.168.170.131/mpcRun, https://192.168.170.132/mpcRun] may be generated.

Also, the MPC execution preparation function may set the input parameter information required for the MPC execution request and may request MPC execution.

The input parameter information may include the MPC program identifier and the MPC player identifier number for the player's IP address written in the link.

Also, the MPC execution preparation function may generate and return a result of processing preparation for MPC execution based on a result of the response to the MPC execution request.

The MPC execution preparation function may output a processing result code as success/failure.

The MPC execution function is a function to execute an MPC program using the input data and MPC runtime environment data set by all MPC players at the MPC preconfiguration step and to check the computation result.

The MPC execution function may receive an MPC program identifier and an MPC player identifier number.

The MPC execution function may check the storage path of the MPC program associated with the received MPC program identifier.

Also, using the MPC program identifier and the storage path of the MPC program to be executed, the MPC execution function may execute the MPC program.

Also, the MPC execution function may check and output a result of execution of the MPC program.

Also, the MPC execution function may generate and store an MPC program execution log.

Also, the MPC execution function may generate and return an MPC execution processing result.

The MPC execution function may output a processing result code as success/failure.

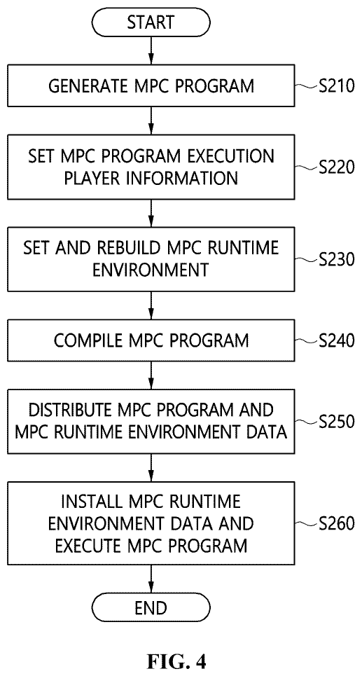

FIG. 4 is a flowchart illustrating an MPC program execution procedure of an apparatus for providing a multi-party computation service according to an embodiment of the present disclosure.

Referring to FIG. 4, it can be seen that the MPC program execution procedure of an apparatus for providing a multi-party computation service is illustrated.

In the MPC program execution procedure, an MPC program may be developed and distributed by one of the players that execute the MPC program or a third party who does not participate in execution of the MPC program.

The apparatus for providing a multi-party computation service according to an embodiment of the present disclosure may generate an MPC program at step S210.

That is, in order to provide the service while preserving privacy for personal information, an MPC program capable of processing computation for the input data of a player as multi-party computation may be implemented and generated at step S210.

Also, the apparatus for providing a multi-party computation service according to an embodiment of the present disclosure may set information about the players to execute the MPC program at step S220.

That is, at step S220, MPC player network information may be generated by collecting information about the players to execute the MPC program, and the MPC player network information may be set in the MPC runtime environment.

Here, the player network information may include the number of players and the identifier numbers and network information for the players.

Here, the network information of the players may include the IP addresses of the general-purpose MPC servers installed and operated by the respective players and SSL certificate information for secure communication between the players.

Here, the identifier numbers for the players may be assigned by the developer such that the identifier numbers are not duplicated.

Here, the player corresponding to the first identifier of the identifier numbers may take a role of an MPC execution administrator who manages the overall process of MPC program execution. Generally, the general-purpose MPC server of the developer who develops and distributes the MPC program may be assigned the first identifier.

Also, the apparatus for providing a multi-party computation service according to an embodiment of the present disclosure may rebuild the MPC runtime environment configuration and the runtime environment at step S230.

That is, at step S230, the runtime environment for generating MPC runtime environment data may be rebuilt in the state in which player data information is set in the MPC runtime environment.

Here, the system rebuilding may include setting a secret sharing type, which is a sharing scheme for securely partitioning and storing confidential information or data in the MPC protocol, or settings for circuit conversion processing.

Here, at step S230, when the system rebuilding is completed, environment configuration data for the MPC runtime environment may be generated.

Here, the MPC runtime environment configuration data may include secret sharing data and circuit conversion data.

Also, the apparatus for providing a multi-party computation service according to an embodiment of the present disclosure may compile the MPC program at step S240.

That is, at step S240, the generated MPC program may be compiled in the state in which rebuilding the MPC runtime environment is completed.

Here, at step S240, when the compilation is completed normally, an MPC program executable file in a bytecode format capable of being executed in the MPC runtime engine can be seen.

Also, the apparatus for providing a multi-party computation service according to an embodiment of the present disclosure may distribute the MPC program and the MPC runtime environment data at step S250.

That is, at step S250, the generated MPC program and MPC runtime environment configuration data may be distributed to all players.

Here, the MPC runtime environment data may include the secret sharing data, the circuit conversion data, MPC player network data, and the like.

Also, the apparatus for providing a multi-party computation service according to an embodiment of the present disclosure may install the MPC runtime environment data and execute the MPC program at step S260.

That is, at step S260, all of the players may install the received MPC program and MPC runtime environment data in the MPC runtime environment and execute the MPC program.

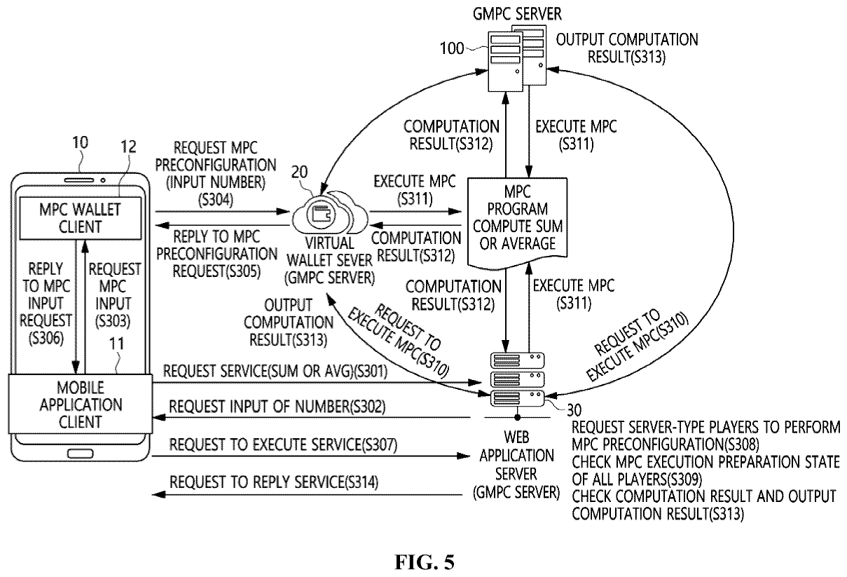

FIG. 5 is a view illustrating the operating procedure of a multi-party computation system according to an embodiment of the present disclosure.

Referring to FIG. 5, the configuration of the following service environment is described in order to explain execution and operation of various types of multi-party computation (MPC) programs using a General Multi-Party Computation (GMPC) server corresponding to the apparatus for providing a multi-party computation service according to an embodiment of the present disclosure.

A web application server 30 may correspond to the MPC execution administrator that develops and distributes a sum program and an average program for the numbers input by all players through multi-party computation.

A user device 10 may execute the sum or average program provided by the web application server 30 by using a mobile application client 11.

The value input by a user is not exposed to other players, and all players may check only the result of the computation.

Using the mobile application client 11, the user device 10 may request a multi-party computation service so as to execute either the sum program or the average program provided by the web application server 30 at step S301.

The web application server 30 may request input of the number to be computed via the mobile application client 11 at step S302.

The mobile application client 11 may request an MPC wallet client 12, which is trusted by a user and is capable of processing multi-party computation, to input the user's number to be computed, rather than directly receiving the number to be computed, at step S303.

The user device 10 may receive user information through the mobile application client 11, but when the user does not want to expose the user's personal information or confidential information to the service server, the user may use a third-party's application client that is trusted by the user and is capable of processing multi-party computation.

The MPC wallet client 12 may receive the number to be computed from the user in response to the request from the mobile application client 11 and transmit the received number to a virtual wallet server 20 at step S304.

The virtual wallet server 20 may set the number received from the user device 10 as input data for executing an MPC program at step S305.

Here, at step S305, the virtual wallet server 20 may check the player identifier number thereof in MPC player network data, which is the MPC runtime environment data associated with the MPC program, and return the same.

Here, at step S305, returning the player identifier number means notifying the MPC execution administrator of the completion of the preconfiguration step for executing the corresponding MPC program.

The MPC wallet client 12 may transfer the player identifier number received from the virtual wallet server 20 to the mobile application client 11 at step S306.

The mobile application client 11 may request execution of the service at step S307 by transferring the player identifier number received from the MPC wallet client 12 to the web application server 30.

The web application server 30 may check the player identifier number received from the mobile application client 11 at step S308.

Here, at step S308, the MPC execution preparation state for the corresponding player identifier number may be updated to an enabled state in the MPC player network data, which is the MPC runtime environment data associated with the MPC program, the execution of which is requested by the user.

Here, at step S308, the web application server 30, which is the MPC execution administrator, may request server-type players to perform MPC server preconfigurations through MPC player network information.

Here, the types of players may be categorized into a server type and a client type.

The server type is an environment in which it is easy to use a fixed IP and may correspond to a player capable of handling requests related to MPC preconfiguration and execution from the MPC execution administrator in real time.

The client type is an environment in which it is difficult to use a fixed IP and may correspond to a player that cannot handle requests related to MPC preconfiguration and execution from the MPC execution administrator in real time. For example, a device such as a mobile communication terminal may be a client-type player.

The web application server 30 may update the MPC execution preparation states for all players based on a result of the response to the MPC preconfiguration request and check the MPC execution preparation states at step S309.

When the MPC execution preparation states for all of the players are the enabled states, the web application server 30 may request all of the players to perform MPC execution at step S310.

All of the MPC players may execute the MPC program in response to the MPC execution request from the web application server 30 at step S311.

Each of the MPC players may selectively return the computation result of the MPC program to all of the players or a specific player at step S312.

All of the MPC players may check and output the computation result of the MPC program at step S313.

The web application server 30 may send the application client 11 the computation result of the MPC program as a mobile response message at step S314.

The mobile application client 11 may check the computation result of the MPC program and output the same to the user at step S315.

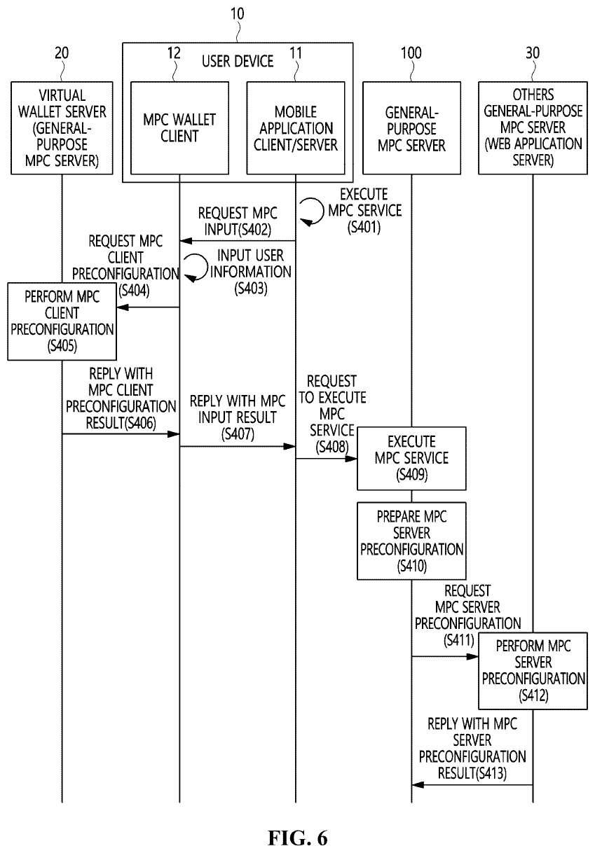

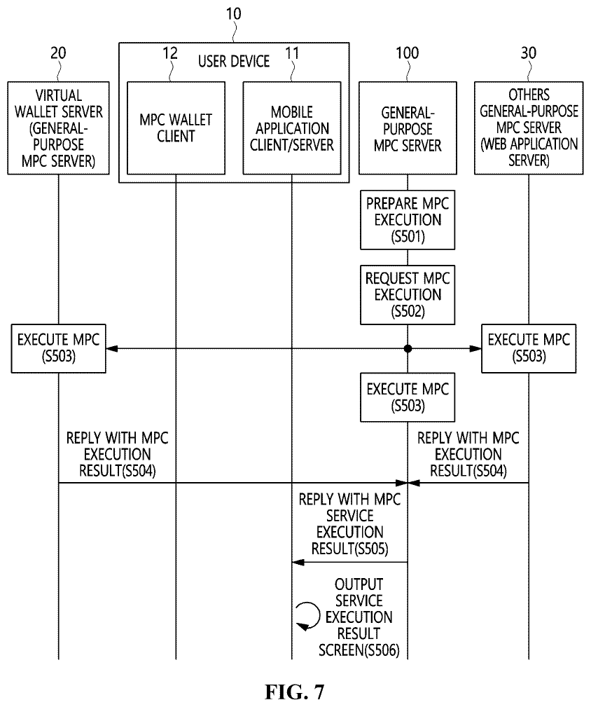

FIG. 6 and FIG. 7 are sequence diagrams illustrating a method for providing a multi-party computation service according to an embodiment of the present disclosure.

Referring to FIG. 6, a user device 10 may execute a sum program or an average program, which are multi-party computation programs provided by a web application server 30, using a mobile application client 11 at step S401.

Here, the mobile application client 11 may check an MPC program identifier for the multi-party computation program selected by a user.

The mobile application client 11 may request an MPC wallet client 12, which is trusted by the user and is capable of processing multi-party computation, to input the user's number to be computed, rather than directly receiving the number to be computed, at step S402.

Here, the MPC input request may include the MPC program identifier, a user ID, a personal information identifier, and the like.

Here, the user ID may be a user ID for the service or Connecting Information (CI) generated based on the social security number of the user.

Here, the CI may be used as user identification information for retrieving the personal information of the user registered in the systems of different players.

The MPC wallet client 12 may receive the number to be computed from the user in response to the request from the mobile application client 11 at step S403.

The MPC wallet client 12 may request a virtual wallet server 20 to perform an MPC client preconfiguration at step S404.

Here, the MPC client preconfiguration request may include the MPC program identifier, the user ID, the personal information identifier, information input by the user, and the like.

The virtual wallet server 20 may process the MPC client preconfiguration content at step S405 and reply to the MPC wallet client 12 with a result of processing the MPC client preconfiguration at step S406.

The MPC wallet client 12 may reply to the mobile application client 11 with an MPC input result at step S407.

Here, the MPC input result may include the MPC player identifier number of the virtual wallet server 20.

The mobile application client 11 may request a GMPC server 100 to execute the multi-party computation program selected by the user at step S408.

Here, the multi-party computation execution request may include the MPC program identifier, the MPC player identifier number of the virtual wallet server, the user ID, the personal information identifier, and the like.

Here, the user ID may be a user ID for the service or Connecting Information (CI) generated based on the social security number of the user.

Here, the CI may be used as user identification information for retrieving the personal information of the user registered in the systems of different players.

The GMPC server 100 may process a multi-party computation service execution function, generate a processing result, and return the processing result to the mobile application client at step S409.

The GMPC server 100 may execute an MPC server preconfiguration preparation function such that the web application servers 30 participating in the multi-party computation service execute the multi-party computation program at step S410.

Here, at step S410, the IP information of server-type players may be identified in the MPC player network data associated with the MPC program to be executed, and a link through which a request to perform an MPC server preconfiguration can be made to the identified server-type players. Only an MPC execution administrator may perform this function.

Here, at step S410, an MPC program identifier and a user ID may be received.

Here, at step S410, the received user ID may be checked.

Here, at step S410, the IP information of the server-type players may be identified in the MPC player network data for the MPC program associated with the received MPC program identifier, and a link for requesting the server-type players to perform an MPC server preconfiguration may be generated as follows.

A link in the form of ‘https://IP address of the identified player/mpcXXX’ may be generated.

For example, a link such as [https://192.168.170.131/mpcSimple_sum, https://192.168.170.132/mpcSimple_sum] may be generated.

Here, at step S410, input parameter information required for the MPC server preconfiguration request may be set and requested.

The input parameter information may include the identifier of the MPC program to be executed, user ID information, and a personal information identifier.

Here, at step S410, a result of processing the MPC server preconfiguration preparation may be generated and returned.

Here, at step S410, a processing result code may be output as success/failure.

Here, at step S410, the GMPC Server 100 may execute the MPC server preconfiguration preparation function based on network data information, an MPC runtime environment configuration file, and a certificate file.

The network data information may include an MPC player identifier, an IP address, a certificate file name, the CommonName (CN) value of a certificate, and an MPC player server type.

The MPC player identifier may indicate identifier information for an MPC player. Generally, the first identifier is assigned to the MPC execution administrator, and whether the type is an MPC player server type may be set.

The IP address is the IP address of the general-purpose MPC server installed and operated by the MPC player.

CertFileName indicates the SSL certificate file name of the general-purpose MPC server installed and operated by MPC player. CertFileName may be used later when an MPC runtime engine establishes SSL communication between the general-purpose MPC servers of different players. CertFileName may be managed not only for the SSL certificate file name, but also for the storage path of the certificate file.

Here, at step S410, the network information is retrieved, and SSL communication with the multi-party computation player servers may be established based on the certificate file.

Cert-CN is the CommonName (CN) value of the SSL certificate of the general-purpose MPC server installed and operated by the MPC player. Cert-CN may be used later when the MPC runtime engine establishes SSL communication between the general-purpose MPC servers of different players.

The GMPC server 100 may transmit the MPC preconfiguration information to the web application servers 30 participating in the multi-party computation service and request the web application servers 30 to perform the MPC preconfiguration at step S411.

Here, at step S411, the preconfiguration request may be made to the multi-party computation player servers participating in the multi-party computation service based on the multi-party computation runtime environment data.

Here, at step S411, the GMPC server 100 may request the web application servers 30 corresponding to the MPC players to perform the MPC preconfiguration based on the network data information.

Here, the MPC preconfiguration information may include an MPC program file, the MPC environment configuration file, and the certificate file.

The web application servers 30 may perform the MPC preconfiguration using the MPC preconfiguration information at step S412.

The MPC server preconfiguration function may process a function to set MPC input data for a server-type player, among the MPC player types, and a function to install the MPC program to be executed and the MPC runtime environment data associated with the MPC program in the MPC runtime environment.

Here, step S412 may be performed when the MPC execution administrator makes a request.

Here, at step S412, an MPC program identifier, a user ID, and a personal information identifier may be received.

Here, at step S412, whether the MPC program and the MPC runtime environment data associated with the received MPC program identifier are stored may be checked.

Here, at step S412, when the MPC program and the MPC runtime environment data are present, the MPC program and the MPC runtime environment data may be installed in the MPC runtime environment.

Here, at step S412, the player identifier number of the web application server may be checked using the MPC player network information in the retrieved MPC runtime environment data.

Here, at step S412, the player identifier number matching the IP address of the web application server may be checked in the MPC player network information.

Here, at step S412, when there is a received user ID or personal information identifier, the personal information of the user may be retrieved from a user DB, and the retrieved personal information may be installed in the MPC runtime environment as the input data of the player.

Here, the user ID may be a user ID for the service or Connecting Information (CI) generated based on the social security number of the user.

Here, the CI may be used as user identification information for retrieving the personal information of the user registered in the systems of different players.

The web application server 30 may reply to the GMPC server 100 with a result of the MPC preconfiguration at step S413.

Here, at step S413, a result of processing the MPC server preconfiguration may be generated and returned.

Here, at step S413, a processing result code may be output as success/failure.

Here, at step S413, the MPC player identifier number may be output.

Referring to FIG. 7, the GMPC server 100 may confirm the completion of the MPC preconfiguration and execute an MPC execution preparation function at step S501.

Here, at step S501, the MPC player identifier number received as the result of the response to the MPC server preconfiguration request may be checked, and the MPC execution preparation state for the corresponding MPC player identifier number may be updated to an enabled state.

The GMPC server 100 may request the virtual wallet server 20 and the web application server 30 to perform MPC execution at step S502.

The GMPC server 100, the virtual wallet server 20, and the web application server 30 may simultaneously execute multi-party computation in response to the MPC execution request at step S503.

Here, at step S503, the IP information of all players is identified in the MPC player network data associated with the MPC program to be executed, and a link through which a request to perform MPC execution can be made to all of the identified players may be generated. Only the MPC execution administrator may perform this function.

Here, at step S503, when the MPC server preconfiguration is completed, the GMPC Server 100, the virtual wallet server 20, and the web application server 30 may execute the multi-party computation immediately upon receiving the request to execute the multi-party computation service from the user device 10, but when the MPC server preconfiguration is not completed, the multi-party computation may be simultaneously executed at a preset time after the MPC server preconfiguration is completed.

Here, at step S503, an MPC program identifier may be received.

Here, at step S503, the IP information of all players may be identified in the MPC player network data for the MPC program associated with the received MPC program identifier, and a link for requesting all of the players to perform MPC execution may be generated as follows.

A link in the form of ‘https://IP address of identified player/mpcRun’ may be generated.

For example, a link such as [https://192.168.170.131/mpcRun, https://192.168.170.132/mpcRun] may be generated.

Here, at step S503, input parameter information required for the MPC execution request may be set, and MPC execution may be requested.

The input parameter information may include the MPC program identifier and the MPC player identifier number for the player IP address written in the link.

Here, at step S503, all of the MPC players may execute the MPC program using the input data and MPC runtime environment data set at the MPC preconfiguration step and may check a computation result.

Here, at step S503, the MPC program identifier and the MPC player identifier number may be received.

Here, at step S503, the storage path of the MPC program associated with the received MPC program identifier may be checked.

Here, at step S503, the MPC program may be executed using the MPC program identifier and the storage path of the MPC program to be executed.

The virtual wallet server 20 and the web application server 30 may reply to the GMPC Server 100 with the MPC execution result at step S504.

Here, at step S504, a result of processing the MPC execution preparation may be generated based on the result of the response to the MPC execution request and may then be returned.

Here, at step S504, a processing result code may be output as success/failure.

Here, at step S504, the MPC program execution result may be checked and output.

Here, at step S504 an MPC program execution log may be generated and stored.

Here, at step S504, an MPC execution processing result may be generated and returned.

Here, at step S504, the processing result code may be output as success/failure.

The GMPC server 100 may transmit a multi-party computation service execution result to the mobile application client 11 at step S505.

The mobile application client 11 may check and output the multi-party computation service execution result at step S506.

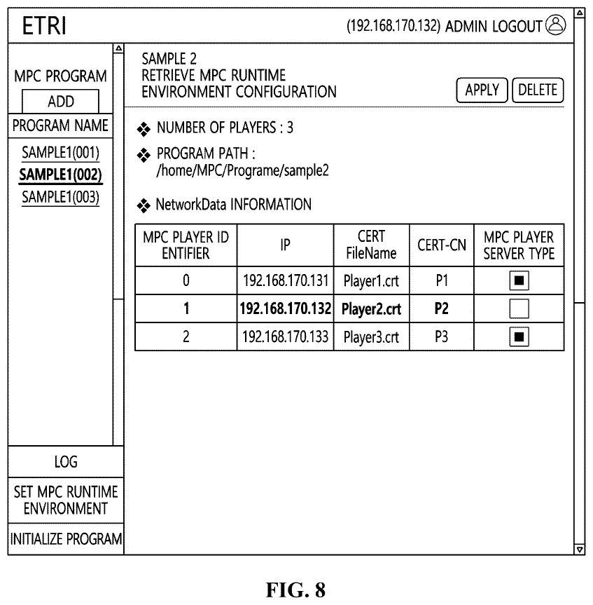

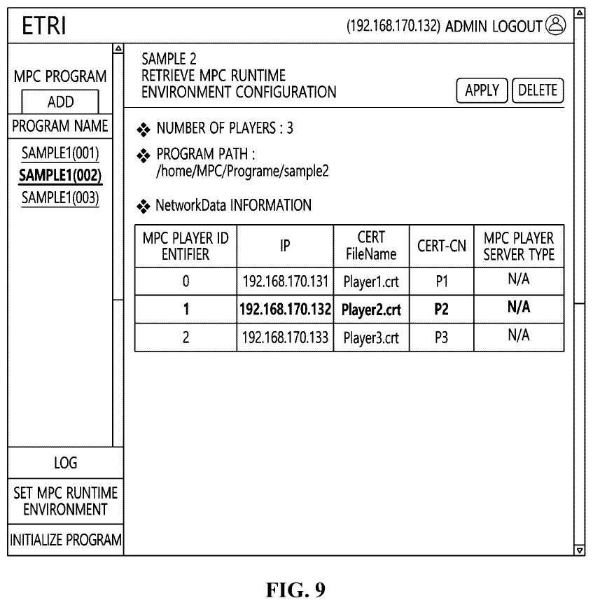

FIG. 8 is a view illustrating a GUI for retrieving and managing MPC runtime environment configuration data of an MPC execution administrator according to an embodiment of the present disclosure. FIG. 9 is a view illustrating a GUI for retrieving and managing MPC runtime environment configuration data of a general MPC player according to an embodiment of the present disclosure.

Referring to FIG. 8, it can be seen that a function to retrieve and manage a multi-party computation (MPC) program and MPC runtime environment configuration data associated with the corresponding program based on the GUI is illustrated. It can be seen that this screen shows the management screen of an MPC execution administrator. The MPC execution administrator may correspond to an GMPC server 100, which is the above-described apparatus for providing a multi-party computation service.

Here, the GUI screen may be output through a user device 10.

The ‘MPC player identifier’ field may indicate identifier information of MPC players. Generally, the first identifier indicates the MPC execution administrator, and the MPC execution administrator may set whether the type is an MPC player server type.

The ‘IP’ field indicates the IP address of a general-purpose MPC server installed and operated by an MPC player.

The ‘CertFileName’ field indicates the name of the SSL certificate file of the general-purpose MPC server installed and operated by the MPC player. The ‘CertFileName’ field may be used later when an MPC runtime engine establishes SSL communication between the general-purpose MPC servers of different players. The ‘CertFileName’ field may be managed not only for the name of the SSL certificate file but also for the storage path of the certificate file.

The ‘Cert-CN’ field indicates the CommonName (CN) value of the SSL certificate of the general-purpose MPC server installed and operated by the MPC player. The ‘Cert-CN’ field may be used later when the MPC runtime engine establishes SSL communication between the general-purpose MPC servers of different players.

The ‘MPC Player Server Type’ field indicates a server type, among the types of MPC players. The server type is an environment in which it is easy to use fixed IP, and may indicate a player capable of processing requests related to MPC preconfiguration and execution from the MPC execution administrator in real time.

The ‘MPC Player Server Type’ field may be changed by only the MPC execution administrator and may be used later to select the target to which a request to perform MPC server preconfiguration is to be made at the MPC server preconfiguration preparation step.

Referring to FIG. 9, a function to retrieve and manage a multi-party computation (MPC) program and MPC runtime environment configuration data associated with the corresponding program based on a GUI is illustrated, and it can be seen that this screen shows the GUI screen for retrieving and managing the MPC runtime environment configuration data of a general MPC player, rather than an MPC execution administrator.

Here, the GUI screen may be output through a user device 10.

The general MPC player may correspond to the virtual wallet server 20 and web application server 30 described above.

The functions illustrated in FIG. 9 are identical to the functions in the screen for the MPC execution administrator illustrated in FIG. 8, but all of the values of the ‘MPC Player Server Type’ field may be written as N/A because there is no authority to change the type.

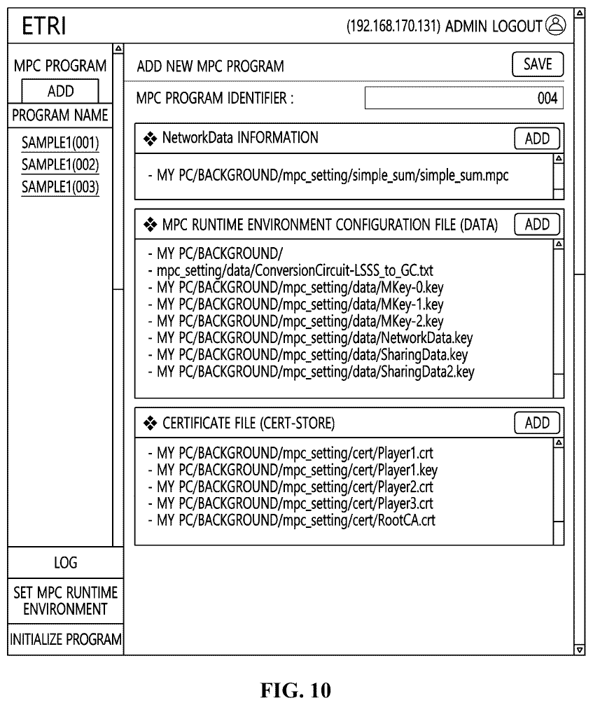

FIG. 10 is a view illustrating a GUI for additionally storing MPC runtime environment configuration data according to an embodiment of the present disclosure.

Referring to FIG. 10, it can be seen that this screen shows a function to additionally store a new multi-party computation (MPC) program and MPC runtime environment configuration data associated with the corresponding program based on a GUI.

Here, the GUI screen may be output through a user device 10.

In this screen, the same UI screen may be used for both the MPC execution administrator and the general MPC player.

The function to add MPC environment configuration data may store and manage an MPC Program Identifier (MPI), an MPC program file, an MPC runtime environment configuration file, and a certificate file for each MPC program in conjunction with each other.

The ‘MPC Program Identifier (MPI)’ field may indicate an MPC program identifier.

The MPI in the form of a number may be generated and distributed by an MPC program developer, or a hash value for the program may be used as the identifier. The identifier may be managed as a unique identifier.

It can be seen that MPC program files indicate a function to add the MPC program distributed by the developer and a compiled file for MPC program.

For example, ‘simple_sum.mpc’ is an MPC program file implemented in Mamba language.

It can be seen that ‘MPC runtime environment configuration file (DATA)’ indicates the function to add the MPC runtime environment configuration data associated with the MPC program distributed by the developer.

For example, ‘ConversionCircuit-LSSS_to_GC.txt’ may contain information about circuits to convert Garbled Circuits (GC) into Linear Secret Sharing (LSSS).

‘mpc_setting/data/MKey-0.key’ may include Message Authentication Code (MAC) key information for the MPC players.

‘NetworkData.key’ may include network information for all MPC players that execute the Mamba program.

For example, RootCA.crt, corresponding to the network information included in NetworkData.key, may correspond to a root certificate for verifying SSL certificates for the players.

For example, RootCA.crt may include the total number of players executing the Mamba program (4), a player variable (0), a Player IP (127.0.0.1), the name of the SSL certificate file of a player (Player1.crt), and the CN value of the SSL certificate of the player (P1), as illustrated in FIG. 8 and FIG. 9.

‘SharingData.key’ may include information defining data required for secret sharing processing, such as the modulus of the finite field, and the like.

It can be seen that ‘Certificate file (Cert-Store)’ indicates the function to add the SSL certificate files of the players of the MPC program distributed by the developer.

‘Player1.crt’ may include SSL certificate information for the MPC player 1.

‘Player1.key’ may include the private key information of the SSL certificate for the MPC player 1.

‘Player2.crt’ may include SSL certificate information for the MPC player 2.

‘Player3.crt’ may include SSL certificate information for the MPC player 3.

‘RootCA.crt’ may include root certificate information for the SSL certificates of the MPC players.

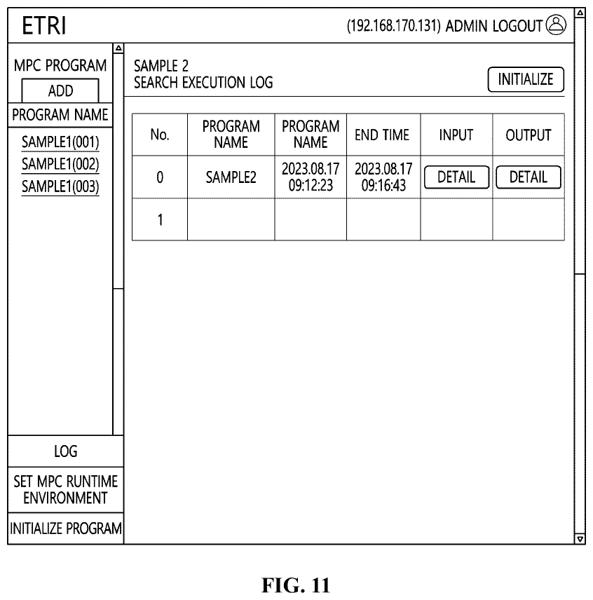

FIG. 11 is a view illustrating a GUI for retrieving an MPC program execution log according to an embodiment of the present disclosure.

Referring to FIG. 11, the ‘ProgramName’ field indicates the name of the executed MPC program.

The ‘Start Time’ field indicates the time at which an MPC execution request for the MPC program is started.

The ‘End Time’ field indicates the time at which the MPC execution request for the MPC program ends.

The ‘Input’ field indicates the input data of a player that is set for execution of the MPC program.

The ‘Output’ field indicates the output data for the MPC program execution result.

Here, the GUI screen may be output through a user device 10.

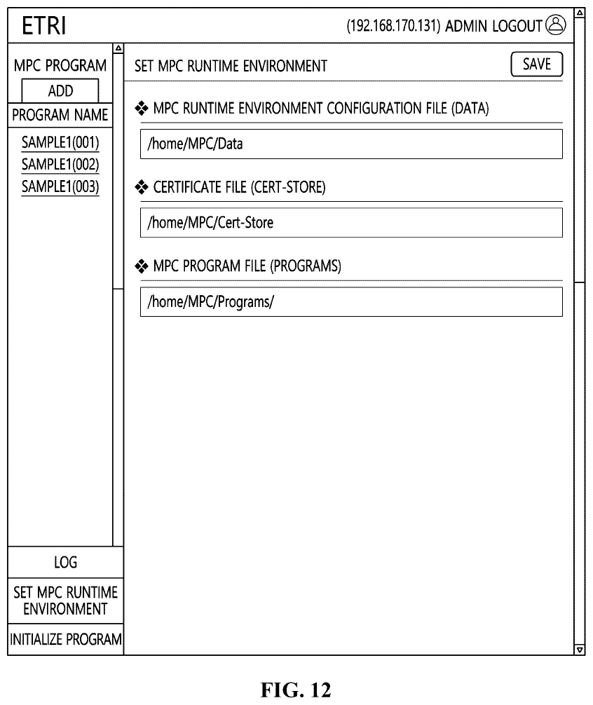

FIG. 12 is a view illustrating an MPC program runtime environment configuration GUI according to an embodiment of the present disclosure.

Referring to FIG. 12, an MPC runtime environment configuration file indicates the path where the MPC runtime environment configuration file associated with an MPC program is to be stored.

The MPC runtime environment configuration file may include player network data, secret sharing data, circuit conversion data, and the like.

‘Certificate file (CERT-STORE)’ indicates the path where the SSL certificates of MPC program players are to be stored.

‘MPC program file’ indicates the path where the MPC program to be executed is to be stored.

Here, the GUI screen may be output via a user device 10.

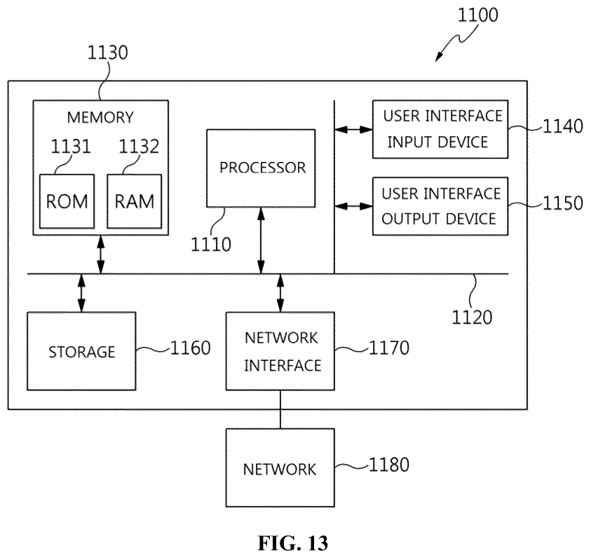

FIG. 13 is a view illustrating a computer system according to an embodiment of the present disclosure.

Referring to FIG. 13, the apparatus for providing a multi-party computation service according to an embodiment of the present disclosure may be implemented in a computer system 1100 including a computer-readable recording medium. As illustrated in FIG. 13, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for providing a multi-party computation service according to an embodiment of the present disclosure includes one or more processors 1110 and memory 1130 for storing at least one program executed by the one or more processors 1110. The at least one program prepares a preconfiguration in response to a request from a user device to execute a multi-party computation service, requests multi-party computation player servers participating in the multi-party computation service to perform the preconfiguration based on multi-party computation runtime environment data, executes multi-party computation with the multi-party computation player servers depending on the preconfiguration, and replies to the user device with a result of execution of the multi-party computation service based on a result of execution of the multi-party computation.

Here, the at least one program may receive a multi-party computation program identifier and a user identifier and check whether a multi-party computation program and multi-party computation runtime environment data associated with the multi-party computation program identifier are stored.

Here, the at least one program may identify the IP information of the multi-party computation player servers in the multi-party computation runtime environment data associated with the multi-party computation program identifier and generate a link for requesting the multi-party computation player servers to perform the preconfiguration based on the IP information.

Here, the at least one program may check the player identifier numbers of the multi-party computation player servers received as a result of the response to the request to perform the preconfiguration and may update the multi-party computation execution preparation states of the multi-party computation player servers for the player identifier numbers to an enabled state.

Here, each of the multi-party computation player servers may check the player identifier number matching the IP address thereof by retrieving network information in the multi-party computation runtime environment data.

Here, the at least one program may establish SSL communication with the multi-party computation player servers based on a certificate file and the CommonName (CN) value of the certificate by retrieving the network information.

Here, the user device may output a GUI for retrieving the multi-party computation runtime environment data.

Here, the user device may receive network information, multi-party computation runtime environment data, and a certificate file from a user through the GUI.

Here, the user device may output a GUI for retrieving an execution log, including the multi-party computation program that executed the multi-party computation, the computation start time, and the computation end time, to the user

Here, the user device may request a multi-party computation player server to prepare a client preconfiguration by receiving data for processing the multi-party computation, and when preparation of the client preconfiguration is completed, the user device may transmit a request to execute the multi-party computation service to the apparatus for providing a multi-party computation service.

The present disclosure may provide the structure of a general-purpose MPC server capable of easily providing MPC preconfiguration and execution tasks for executing a multi-party computation program and the operation method thereof.

Also, the present disclosure may conveniently manage and stably operate various MPC programs.

Also, the present disclosure may facilitate system expansion by easily adding and managing players participating in multi-party computation.

As described above, the apparatus and method for providing a multi-party computation service according to the present disclosure are not limitedly applied to the configurations and operations of the above-described embodiments, but all or some of the embodiments may be selectively combined and configured, so the embodiments may be modified in various ways.

What is claimed is:

1. An apparatus for providing a multi-party computation service, comprising:
one or more processors; and
memory for storing at least one program executed by the one or more processors,
wherein the at least one program
prepares a preconfiguration in response to a request from a user device to execute a multi-party computation service,
requests multi-party computation player servers participating in the multi-party computation service to perform a preconfiguration based on multi-party computation runtime environment data,
executes multi-party computation with the multi-party computation player servers depending on the preconfiguration, and
replies to the user device with a result of execution of the multi-party computation service based on a result of executing the multi-party computation.

2. The apparatus of claim 1, wherein the at least one program receives a multi-party computation program identifier and a user identifier and checks whether a multi-party computation program and multi-party computation runtime environment data associated with the multi-party computation program identifier are stored.

3. The apparatus of claim 2, wherein the at least one program identifies IP information of the multi-party computation player servers in the multi-party computation runtime environment data associated with the multi-party computation program identifier and generates a link for requesting the multi-party computation player servers to perform the preconfiguration based on the IP information.

4. The apparatus of claim 3, wherein the at least one program checks player identifier numbers of the multi-party computation player servers, received as a result of a response to a request to perform the preconfiguration, and updates multi-party computation execution preparation states of the multi-party computation player servers corresponding to the player identifier numbers to an enabled state.

5. The apparatus of claim 4, wherein each of the multi-party computation player servers checks a player identifier number matching an IP address thereof by retrieving network information in the multi-party computation runtime environment data.

6. The apparatus of claim 5, wherein the at least one program retrieves the network information and establishes SSL communication with the multi-party computation player servers based on a certificate file and a CommonName (CN) value of a certificate.

7. The apparatus of claim 1, wherein the user device outputs a Graphical User Interface (GUI) for retrieving the multi-party computation runtime environment data to a user.

8. The apparatus of claim 7, wherein the user device receives network information, multi-party computation runtime environment data, and a certificate file from the user via the GUI.

9. The apparatus of claim 1, wherein the user device outputs a GUI for retrieving an execution log, including a multi-party computation program that executed the multi-party computation, a computation start time, and a computation end time, to a user.

10. The apparatus of claim 1, wherein the user device requests a multi-party computation player server to prepare a client preconfiguration by receiving data for processing the multi-party computation, and when preparation of the client preconfiguration is completed, the user device transmits a request to execute the multi-party computation service to the apparatus.

11. A method for providing a multi-party computation service, performed by an apparatus for providing a multi-party computation service, comprising:
preparing a preconfiguration in response to a request from a user device to execute a multi-party computation service;
requesting multi-party computation player servers participating in the multi-party computation service to perform a preconfiguration based on multi-party computation runtime environment data;
executing multi-party computation with the multi-party computation player servers depending on the preconfiguration; and
replying to the user device with a result of execution of the multi-party computation service based on a result of executing the multi-party computation.

12. The method of claim 11, wherein preparing the preconfiguration comprises receiving a multi-party computation program identifier and a user identifier and checking whether a multi-party computation program and multi-party computation runtime environment data associated with the multi-party computation program identifier are stored.

13. The method of claim 12, wherein requesting to perform the preconfiguration comprises identifying IP information of the multi-party computation player servers in the multi-party computation runtime environment data associated with the multi-party computation program identifier and generating a link for requesting the multi-party computation player servers to perform the preconfiguration based on the IP information.

14. The method of claim 13, wherein executing the multi-party computation comprises checking player identifier numbers of the multi-party computation player servers, received as a result of a response to a request to perform the preconfiguration, and updating multi-party computation execution preparation states of the multi-party computation player servers corresponding to the player identifier numbers to an enabled state.

15. The method of claim 14, wherein executing the multi-party computation comprises checking, by each of the multi-party computation player servers, a player identifier number matching an IP address thereof by retrieving network information in the multi-party computation runtime environment data.

16. The method of claim 15, wherein executing the multi-party computation comprises retrieving the network information and establishing SSL communication with the multi-party computation player servers based on a certificate file and a CommonName (CN) value of a certificate.

17. The method of claim 11, wherein the user device outputs a Graphical User Interface (UI) for retrieving the multi-party computation runtime environment data to a user.

18. The method of claim 17, wherein the user device receives network information, multi-party computation runtime environment data, and a certificate file from the user via the GUI.

19. The method of claim 11, wherein the user device outputs a GUI for retrieving an execution log, including a multi-party computation program that executed the multi-party computation, a computation start time, and a computation end time, to a user.

20. The method of claim 1, wherein preparing the preconfiguration comprises requesting, by the user device, a multi-party computation player server to prepare a client preconfiguration by receiving data for processing the multi-party computation and transmitting, by the user device, a request to execute the multi-party computation service to the apparatus for providing a multi-party computation service when preparing the client preconfiguration is completed.
